(19) United States
(12) Patent Application Publication
(10) Pub. No.: US 2008/0154774 A1
(43) Pub. Date: Jun. 26, 2008

(54) SYSTEMS AND METHODS FOR MANAGING ACCESS TO REAL ESTATE CONTENT

(75) Inventors: Jack Dennison, Westlake Village, CA (US); Joe DeTuno, Thousand Oaks, CA (US); Sean Whitley, Los Angeles, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Move, Inc.

(21) Appl. No.: 11/614,640

(22) Filed: Dec. 21, 2006

(51) Int. Cl. H04L 9/32

(52) U.S. Cl. 705/51

(57) ABSTRACT

A system, method, and computer program product for providing a real estate lockbox. The real estate lockbox manages access over a network to real estate data by restricting access to certain real estate data while providing free access to other real estate data. Access to the restricted, private real estate data may be gained by receiving a real estate lockbox key. As a result, the real estate lockbox serves a similar function as a physical real estate lockbox, but in an online environment—allowing casual access to public real estate data, but requiring more secured access to private real estate data. In one embodiment, the present invention also provides real estate search toolbar in the form of an API to facilitate searching for real estate over a network.

### FIELD OF THE INVENTION

The present invention relates to online real estate services. Specifically, this invention relates to managing access to online real estate content.

### BACKGROUND OF THE INVENTION

Conventionally, a buyer of real estate relies on a realtor or real estate broker to provide the buyer with access to certain properties for the buyer to investigate. Although a buyer may drive through various areas and generate a list of real estate properties of interest based on what is plainly visible, access to the interior of such properties is usually protected from casual observers. A common system used in many areas is a listing service provider, such as a Multiple Listing Service (MLS). Typically, real estate agents or brokers purchase subscriptions from real estate listing service providers so that the real estate agents and brokers representing property sellers may include available properties in a common regional pool. In this manner, real estate agents and brokers representing property buyers will be aware of various real estate properties available for sale in that area. Another typical function provided by a listing service provider is providing controlled access into the physical interiors of the properties for sale through use of lock boxes.

Specifically, to provide controlled access into the interior of properties for sale, listing service providers typically utilize mechanical or electronic key boxes or lockboxes that are attached to the front entrances of properties for sale. Each lockbox includes a lockable enclosure that provides secured access to a mechanical key that unlocks the property for sale. Mechanical lockboxes may be opened using a universal mechanical key that unlocks all lockboxes controlled by the listing service provider. Electronic lockboxes are similarly structured, however they replace the mechanical key used to access the enclosure of the lockbox with an electronic key. In some instances the electronic key may comprise an access code that is entered into the lockbox, in other instances the electronic key may be stored in a memory on a card that is inserted into the lockbox. Electronic lockboxes have become preferable because, unlike their mechanical counterparts, the electronic lockboxes offer greater security and control over access to the key that unlocks the property for sale. Additionally, the electronic key allows the ability to track accesses to the property by agent or broker and by time.

The internet allows sellers of real estate to reach more potential buyers than ever before. Many real estate agents, brokers, and/or associations (referred to herein collectively as “real estate agents”) currently host internet web sites that include searchable real estate listings provided by listing service providers. These websites are freely available to the public and allow potential buyers to view multiple real estate listings through an online experience. In many instances, real estate listings include various photographs of different portions of the property, such as different rooms of a house. In other instances, listings may include rich media, such as, but not limited to, 360 degree views or virtual tours of different portions of the property.

Unfortunately, the internet traffic through these properties is largely unsecured and may be considered the online equivalent to leaving the front door of a home wide open, thus allowing any mildly curious party to virtually view the property. For many sellers, this creates a difficult dilemma. On the one hand, including data beyond a textual description of the property increases the possibility of finding interested buyers. On the other hand, any person with access to the internet may casually gain virtual entry into the property. Once inside, the person is able to view areas of the property that a seller may prefer to keep more secure from casual online surfers, but would be willing to show more interested online buyers.

Additionally, because the internet traffic through these properties is not heavily controlled, real estate agents may not easily capture data relating to accesses to the property. For example, an online visitor who is casually surfing through available properties may not be discernable from an online visitor who is actively searching through the available properties in anticipation of a potential purchase.

As a result, there is a need for systems and methods for providing online security procedures for allowing access by the public to sensitive information relating to real estate property. In particular, systems and methods are needed to provide online similar type functions to those provided by physical real estate lockbox—allowing casual access to the exterior of available real estate properties, but requiring more secured access to the interior and other protected data relating to the property. There is also a need for systems and methods for providing a real estate search toolbar. The real estate search toolbar should provide a user with a customizable real estate search tool that includes tools useful when searching for available real estate. In some embodiments, the real estate search tool should operate as an application separate from the websites being searched by the user so as to provide a universal search tool.

### SUMMARY OF THE INVENTION

The present invention provides systems, methods, and computer program products for managing access to secure data relating to real estate properties. Specifically, in one embodiment the real estate data for one or more properties is classified as either private data not meant for access by the general public or public data meant for access by the general public. In this embodiment, the systems and methods of the present invention associate a security key with the private data so that the private data is not available to the general public and access to the private data is allowed through used of a security key. In this manner, the private information associated with real estate property can be regulated such that a user must pre-register and receive a security key in order to access the private information.

In some embodiments, there may be various pieces of private information where some the information has a higher level of security. In these embodiments, the systems and methods of the present invention may associate different security keys with different levels of private information. Furthermore, the systems and methods of the present invention may require that a user provide additional information and/or payments in order to receive security keys to access higher level information.

The present invention also provides systems, methods, and computer program products that provide a real estate search toolbar in the form of an API that allows a user to sign-in to have access to the private data, search for available real estate property over a network, review such results, save results, etc. The search tool bar is designed to provide a multipurpose user interface allowing the user to search various databases for available real estate.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a typical conventional network environment in accordance with one exemplary embodiment of the present invention;

FIG. 2 is a diagram illustrating the broad concept of a real estate lockbox in accordance with one exemplary embodiment of the present invention;

FIG. 3 is a flow chart illustrating a method of managing access to private real estate data using a real estate lockbox in accordance with one exemplary embodiment of the present invention;

FIG. 4 shows a flow chart illustrating a method of managing access to private real estate data using a real estate lockbox in accordance with one exemplary embodiment of the present invention;

FIG. 5 shows a flow chart illustrating single sign-on reoccurring activity in accordance with one exemplary example of the present invention;

FIG. 6 shows an example of icons that are associated with real estate search tools for a real estate search toolbar in accordance with one exemplary of the present invention;

FIG. 7 shows one exemplary embodiment of a real estate search toolbar; and

FIG. 8 is a block diagram of an exemplary electronic device configured to execute the real estate lockbox or the real estate search toolbar of exemplary embodiments of the present invention.

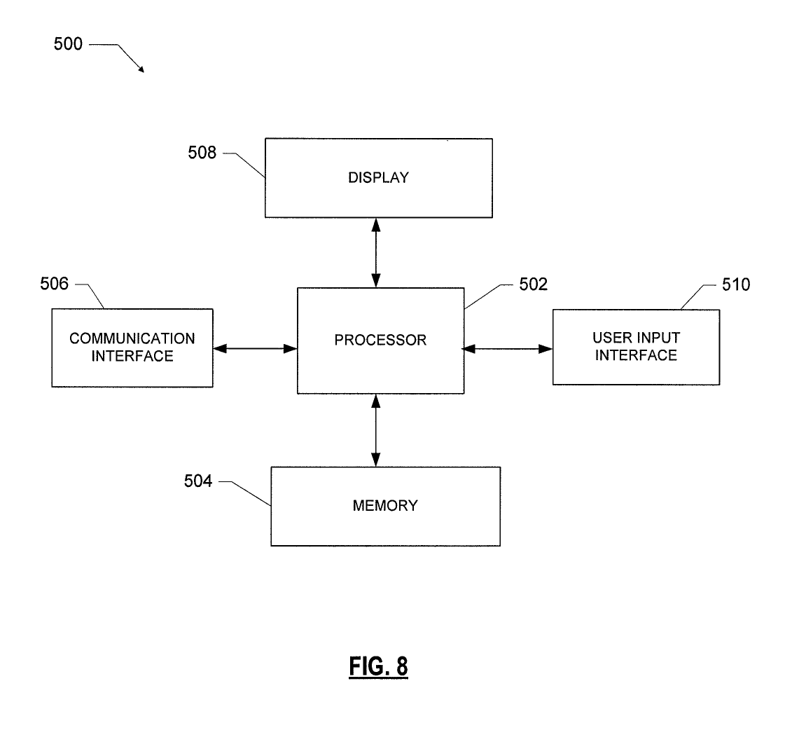

### DETAILED DESCRIPTION OF THE INVENTION

The present invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

As a preliminary matter, the systems, methods, and computer program products of the present invention are described below as they relate to a user searching for available residential real estate listings. However, it is understood that the present invention is applicable to any online real estate listing environment, including, but not limited to, commercial real estate listings, rentals, new construction, real estate parcels, time shares, etc.

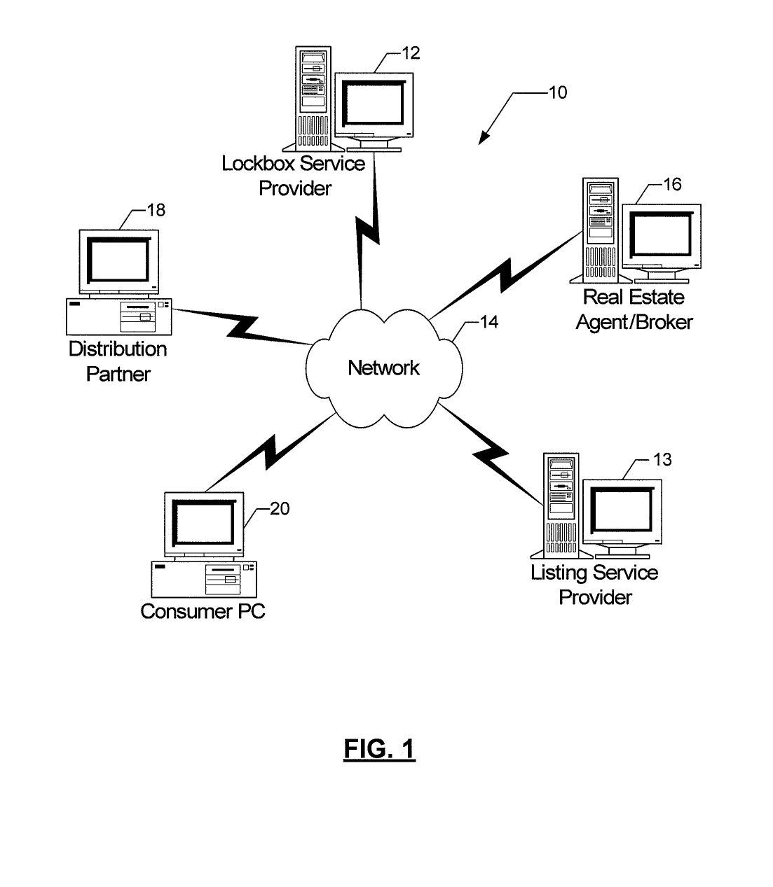

FIG. 1 illustrates an example of a typical network environment 10 in which the systems, methods, and computer program products of the present invention may operate. An exemplary embodiment of the present invention typically may include one or more lockbox service providers 12 and one or more listing service providers 13. A listing service provider 13 may include a server comprising real estate data related to real estate properties, such as real estate properties for construction, sale, rental, lease, or the like. In some embodiments, a lockbox service provider 12 may be a listing service provider 13, however in other embodiments a lockbox service provider 12 may be an independent entity that communicates with a listing service provider 13 and has access to data related to real estate properties listed with the listing service provider 13. Listing service providers may be, for example, multiple listing services (MLS) that gather and store data for various properties. The data on these various servers are typically made available to the public via a network 14 such as a LAN, a WAN, or the Internet. Specifically, users may access and perform searches on one or more of the various property listing providers using a consumer computer 20, such as a PC, connected to the network 14. It is understood that a consumer may be a business, an organization, a person, a group of people, or anyone else who accesses real estate listings.

With regard to FIG. 1, one or more real estate agents 16 may also be connected to the network and may be in communication with the listing service provider 13 and lockbox service provider 12. In such a manner, the real estate agent 16 may submit data relating to real estate properties to the listing service providers 12 to be included on the server. Additionally, various distribution partners 18 may also be connected to the network 14 so as to be in communication with the listing service providers 13 and lockbox service providers 12. A distribution partner 18 is a network host or other entity connected to the network 14 that may receive data from the listing service provider. In various embodiments, a real estate agent 16 may be a distribution partner 18. Distribution partners 18, may also include, but are not limited to, real estate aggregators, various search engines, and syndication partners of real estate aggregators. Exemplary distribution partners include yahoo.com, trulia.com, rent.com, realtor.com, and move.com. In various embodiments, some distribution partners may display public real estate data, however those distribution partners that support communications with a lockbox service provider may display private real estate data. The present invention is usable by a consumer 20, a real estate agent 16, or any other party communicating over the network 14 who is searching for available real estate. Thus, the term “user” will be used herein to define any of such parties.

Virtual Real Estate Lockbox

Under prior art systems, users interested in searching for available real estate properties are able to view most of the data relating to available real estate properties that are included on the server of a listing service provider. This data is freely available to the public. In many instances, real estate listings include textual data, as well as photographs and other rich media data relating to the property. However, the unsecured nature of the prior art system allows mildly curious users to view the same data as consumers who are legitimately searching for available properties. Additionally, data relating to the accesses of the available properties is not reliable because it is not possible to distinguish someone with casual curiosity from a potential buyer.

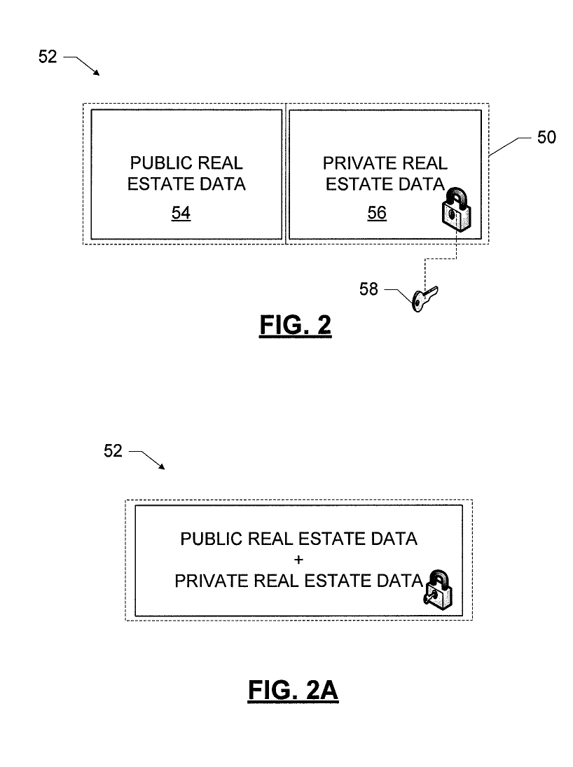

Referring to FIG. 2, the present invention provides a real estate lockbox 50. As with a physical real estate lockbox, the real estate lockbox 50 of the present invention provides a means by which lockbox service providers may control access to certain portions of data relating to real estate property listings. Real estate property submitted by a listing party, such as a seller of the property or a real estate agent of the property, may include real estate property data 52. For the purposes of the current specification and appended claims, real estate property data 52 may be any data and/or information relating to directly or indirectly to a real estate property. Real estate data 52 may include, but is not limited to, textual descriptions of the property, the street address of the property, the selling history of the property, data relating to neighboring sold properties, textual remarks relating to the property, data contained on a property condition form, audio comments relating to the property, inspection reports of the property, surveys and/or site maps of the property, photographs of various portions of the property, a video and/or virtual tour of the property, a video and/or virtual tour of the neighborhood, a video and/or virtual walk-through of the property, a video and/or virtual walk-through of the neighborhood, etc.

Real estate property data 52 for each available real estate property may be divided into public real estate data 54, which relates to real estate property data available to any user who communicates with the lockbox service provider or listing service provider over a network, and private real estate data 56, which relates to real estate property data that is only accessible to users who communicate with the listing service provider over the network and who have access to a lockbox key 58. In various embodiments, a listing party, which may be the seller of the property, a real estate agent, and/or a listing service provider, may determine which portions of the real estate property data 52 may be public real estate data 54 and which portions of the real estate property data 52 may be private real estate data 56. In various embodiments, this determination may be made on a property-by-property basis. In various other embodiments, real estate data 52 of a particular type may be public real estate data 54, while real estate data of another particular type may be private real estate data 56. For example, an exterior photograph and a textual description of the available real estate property may be public real estate data 54, but photographs of the interior of the property and a video walk-through of the property may be private real estate data 56. As another example, if the real estate property is rental property that is up for sale, the average expected rental income could be designated as private real estate data. In some embodiments, the division of real estate property data 52 may be dynamic, allowing a listing party to change public and private real estate data designations over time.

A lockbox key 58 allows a consumer to have access to the private real estate data 56, in addition to the already available public real estate data 54. In various embodiments, the lockbox key 58 may be an authentication token to request private data, or in another embodiment it may be an electronic decryption key that decrypts the private real estate data 56. The electronic decryption key may be stored inside of one or more HTTP session objects, such as cookies that are resident to a browser session.

A registration process requests a consumer to provide certain information in order to be provided with the lockbox key 58. In various embodiments, the information requested of the consumer may be determined by the lockbox service provider. For example, a user may be requested to provide contact information, such as the user's name, address, telephone number, and email address. A login ID and a password may also be requested of the user. The present invention contemplates that different types and/or levels of lockbox keys 58 may be available to a user. For example, in one embodiment a lockbox key 58 may be requested that would allow a user to have access to private real estate data 56 relating to a particular available real estate property, or a particular group of available real estate properties. In another embodiment, a universal lockbox key 58 may be requested that would allow a user to have access to private real estate data 56 relating to all of the available real estate properties listed by a listing service provider as well as providing access to private real estate data 56 relating to available real estate properties listed by other listing service providers. Additionally, in other embodiments, lockbox keys 58 of increasing usability may also be available to a user. For example, a lockbox key 58 of a certain level may allow a user to have access to interior photographs of available properties, while another lockbox key 58 of a different level may allow a user to have access to video tours of the property in addition to the interior photographs. Although in various embodiments the nature and amount of registration information requested from the user may be determined by the lockbox service provider based on its respective needs, in one embodiment a user could be requested for additional information to receive a lockbox key 58 of increased usability.

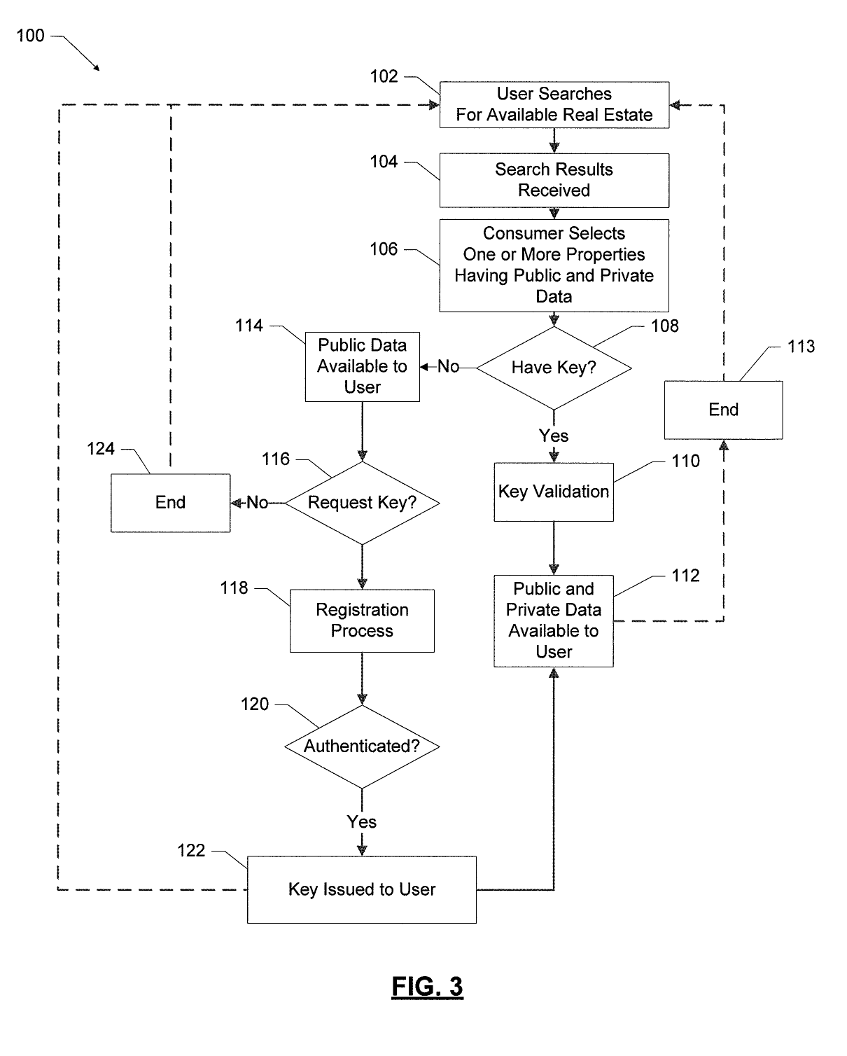

FIG. 3 shows an exemplary embodiment of process 100 in which a user may gain access to private real estate data portions of real estate data. In step 102, a user may search for available real estate properties in a database of available real estate properties. This search may be performed according to any known search method, including communicating with a distribution partner over a network. Typically, a user may submit certain criteria that are then compared to the available real estate listings provided in a database of available properties. In step 104, the results of the search may be provided to the user. Although in some instances there may be no available real estate properties that meet the criteria submitted by the user in step 102, if there are available real estate properties that meet the user's criteria, the user may select one or more properties from the search results as indicated in step 106.

If the user selects a property having an associated lockbox, in step 108 it may be determined whether the user has a lockbox key. If the user does have a lockbox key, the key may then be validated in step 110. In various embodiments, this validation may occur according to any known validation procedure. Once validated, the key may be used to decrypt the private data associated property using any known encryption and decryption method. In another embodiment, the user assigned key may be used as an authentication token, whereby the distribution partner and/or search engine may use this token to request private data for the user's query from the lockbox service provider. The user is thus provided with both public real estate data and private real estate data as indicated in step 112. The process may end as indicated in step 113, or the user may begin another search as indicated in step 102, in which case the flow will repeat as described above.

If, however, the user does not have a lockbox key, only the public real estate data may be provided to the user as indicated in step 114. If the user does not have a lockbox key, the user may have an opportunity to request a lockbox key as indicated in step 116. If the user requests a key, a registration process may be performed as indicated in step 118. During the registration process, registration information such as information associated with the user may be requested. Registration information may be any information associated with the user, and may include, but is not limited to, a user ID, a user password, the user's email address, the user's birth date, the user's phone number, the user's home address, and/or the like. In some embodiments, a payment may also be requested.

In step 120, the registration process may be authenticated. In various embodiments, the authentication may relate to determining whether the user is already registered or verifying the registration information and/or payment information. Once authenticated, a lockbox key may be issued to the user as indicated in step 122. Armed with the lockbox key, the user may have access to the public real estate data and the private real estate data associated with the selected properties. If, however, the user does not request a key, the private real estate data is not displayed. The process may end as indicated in step 124, or the user may begin another search as indicated in step 102, in which case the flow will repeat as described above.

If the user is issued a key, the user may also begin a new search for available real estate properties as indicated in step 102. If the lockbox key issued to the user is of a type that allows the user to have access to private real estate data for a group of real estate properties, any further searches by the user may allow the user access to private real estate data relating to other selected properties in the group. If the lockbox key issued to the user is of a universal type, the lockbox key may allow the user to access private real estate data associated with any property in the database of a particular lockbox service provider and/or other listing service providers.

Lockbox keys in accordance with the present invention may allow a user to have access to private real estate data while the user is in direct communication with a distribution partner that supports communication with a lockbox service provider. In one embodiment, all real estate data relating to available properties is sent by the lockbox service provider to the distribution partner and/or real estate agent through a syndication process, wherein the public real estate data is sent unencrypted and the private real estate data is sent encrypted. Public lockbox keys may also be sent to the distribution partner. When a user requests a lockbox key, the real estate agent may provide the lockbox key to the user. In another embodiment, only the public real estate data associated with the available real estate properties is syndicated and sent to the distribution partner and/or real estate agent. When a user submits an authenticated lockbox key, the distribution partner and/or real estate agent may then request the private real estate data from the lockbox service provider.

In various embodiments, the registration process shown in step 118 may request different levels of registration information associated with the user in various embodiments. As a result, varying levels of professional relationships may be created between a user and a listing service provider, a real estate agent, and/or a distribution partner. In the case of a real estate agent or broker, it is contemplated that in certain embodiments the level of relationship developed between a real estate agent or broker and a user during the registration process 118 may create an agency relationship and/or agreement. If so, this may provide the opportunity for a user to access private real estate data that would otherwise be restricted from distribution by various association rules, such as by regional MLS rules. Additionally, an agency relationship developed between a real estate agent and a user during the registration process 118 may allow the user and real estate agent to interact online in the same manner as a user represented by a real estate agent would interact offline. This may include, but is not limited to, allowing the user to tender and accept offers on available real estate properties through the real estate agent, as well as allowing the user and the real estate agent to form a listing agreement.

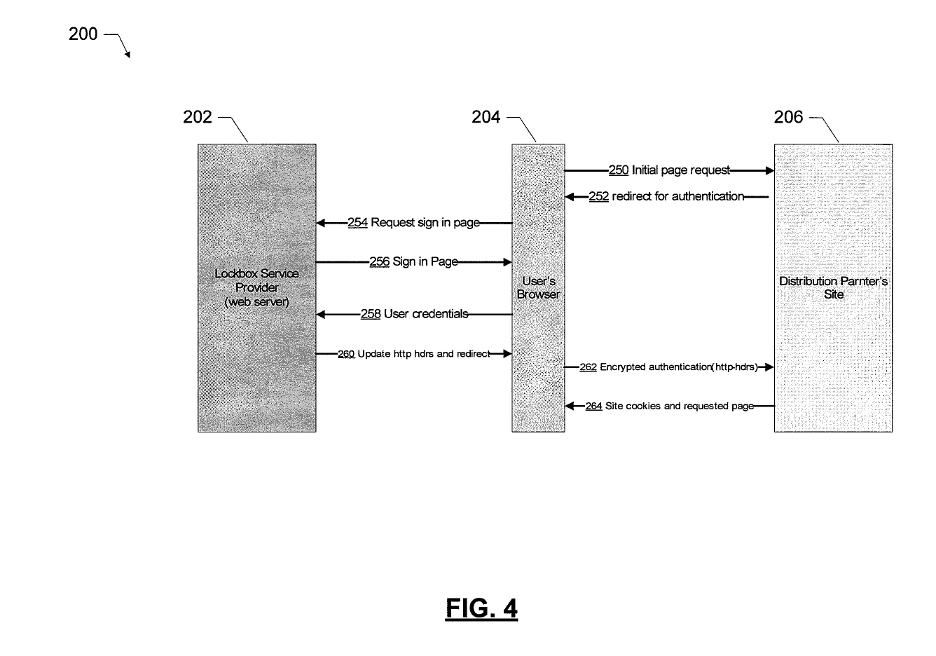

FIG. 4 illustrates an embodiment of the invention in which the lockbox key may provide a single sign-on or unified sign-on model (collectively referred to as “SSO”) in which authenticated users can move easily between applications that require authentication within a network, without having to re-authenticate. Standard SSO protocols currently exist to support these requirements. FIG. 4 illustrates protocol steps 200 for providing a user with access to private real estate data through a real estate lockbox. Elements 202, 204, and 206 represent a lockbox service provider, a user's network browser, and a distribution partner's site, respectively. In step 250 an unauthenticated user accessing a distribution partner's site may request a webpage relating to one or more real estate properties that include private data. In step 252, the site may redirect the user to a real estate lockbox sign-in page via a sign-in graphical user interface (GUI) button. When user presses the button, in step 254 a request is made to the lockbox service provider's server for a sign-in webpage. In this manner, the lockbox service provider may ensure standard steps to secure the HTTP channel to guarantee privacy. In step 256, a sign-in page is sent from the lockbox service provider to the user's browser. Once the sign-in page is received at the user's browser, the user may enter authentication details. In one embodiment, these may be the user's email address and a password previously determined by the user during a registration process. When the user's credentials are submitted to the lockbox service provider in step 258, the credentials are validated. A secure sockets layer (SSL) as in known in the art may be used. Thus, in step 260 the lockbox service provider responds to an authenticated user via an HTTP Redirect pointing back to the distribution partner. The user's browser sends an HTTP request to the distribution partner with supporting authentication information from the lockbox service provider included in the HTTP headers, step 262.

In step 264, the distribution partner site now knows the authentication data, and it distinguishes whether the agent has already pre-authorized the release in a policy or whether it has not. Assuming a successful transaction and an authorized release of the private data to the consumer, the distribution partner site may now also have the authentication key(s), and could now store this data in HTTP session objects, such as cookies for future session accessibility. If the destination site is not satisfied with the lockbox answer, the site may choose to repeat the process from step 252. Various embodiments of these key(s) may now serve different roles. For example, they may be used as authentication tokens for requesting private data from lockbox service providers or they may be used as decryption ciphers to decrypt any private syndicated data.

In this embodiment, participating distribution partner sites may have access to the following values to participate in the data exchange with the lockbox service provider. (1) Default URL, which may be the default location to which users will be redirected in the event of an error or when a particular criteria is not specified; (2) Cobrand Image URL, which may be an image file to be displayed for the standard lockbox service provider login prompt; (3) Cobrand Instruction Text, instruction text that may appear on the distribution partner's site if they so choose to provide their own log-in GUI and channel the credential exchange to the lockbox service provider via web addressable API's; (4) Expire Cookie URL, which may be the location of the URL that is called when the session cookies are expired; and (5) Logout URL, which may be the location to which users may be sent if they sign out of the lockbox by clicking on a lockbox sign out button on a distribution partner site.

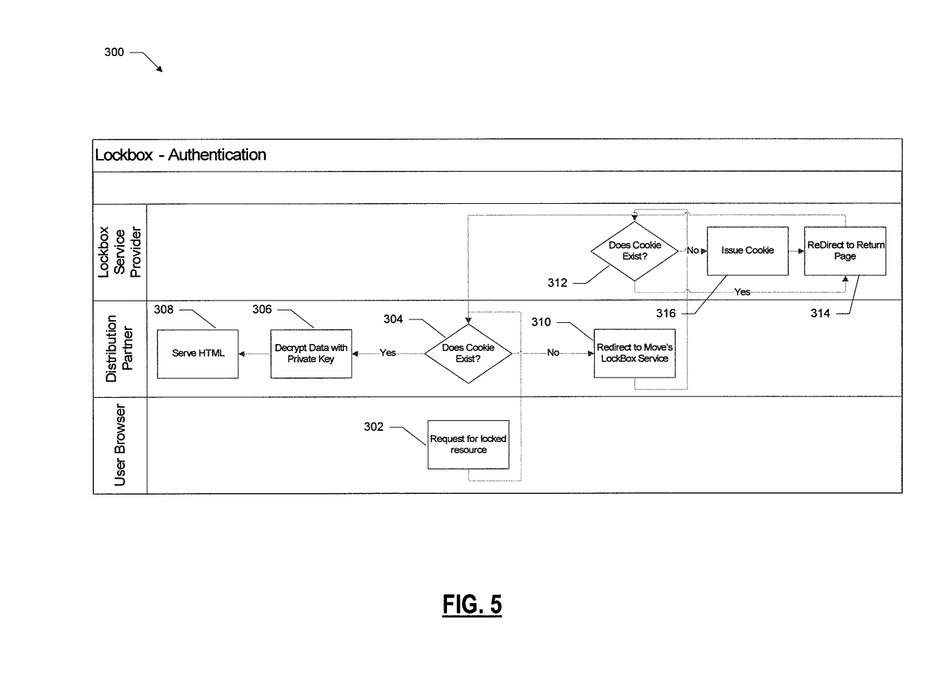

As noted, in various embodiments, the lockbox of the present invention may provide SSO capability. As a result, the authentication and processing of the encrypted data can re-occur during a user's session without requiring the user to unlock the lockbox, provided that the user already has the correct credentials. FIG. 5, illustrates a functional diagram of the re-occurring activities 300 at the lockbox service provider, distribution partner, and user's browser. As shown in the figure, when a user requests additional locked resources as indicated in step 302, such as additional private real estate data, an inquiry is made in step 304 by the distribution partner as to whether a key exists. If a key does exist, the data may be decrypted with the private key in step 306 or requested through an API call to the lockbox service using the key as an authentication token, the HTML is served in step 308. If, however, a key does not exist, in step 310 a redirect is made to the lockbox service provider. In step 312 an inquiry is made at the lockbox service provider as to whether a key exists. If so, in step 314 a redirect is made to return the requested data. If not, a key is issued in step 316, and then a redirect is made to return the requested data.

Real Estate Search Toolbar

The present invention also provides systems, methods, and computer program products relating to a real estate search tool in the form of a downloadable toolbar application. The real estate search toolbar may comprise a frame or special area on a graphical user interface (GUI) of a user's PC that contains an independent display and/or an independent set of controls, and which may be displayed on a user's PC while the user is communicating with a network. The real estate toolbar may comprise a common GUI component that, once downloaded, comprises at least one interactive portion and at least one display portion. The real estate search toolbar can be fully customized by a user. The interactive and display portions may serve various functions, and may include various tools that may be activated via a series of buttons (displayed as icons). The interactive and display portions may also include data entry fields, drop-down boxes, and the like that relate to common functions performed when searching for available real estate.

The real estate search toolbar of some embodiments of the present invention is a separate application program interface (API) that operates separate from the browser used to access various real estate websites. An API is generally an interface that a computer system, library or application provides in order to allow requests for services to be made of it by other computer programs, and/or to allow data to be exchanged between them. The search toolbar of present invention operates as an interface for a user to create various searches. Based on user input, the search toolbar performs searches of various listing service provider, distribution partners, and/or broker agent websites to locate real estate properties of interest. These are returned as results to the user for viewing.

In one exemplary embodiment, a function may be included that allows a user to search for available homes, available new homes, new construction, real estate lots, available rentals, etc. Within each category, the real estate search toolbar may allow a user to enter search criteria relating to the city, state, and/or zip code desired, as well as criteria intended to narrow the search results, such as price information, and the number of bedrooms and bathrooms desired. An advanced search function may also be included that may allow the toolbar to expand so that additional search criteria may be entered by a user. The results of a search may be displayed on the display portion of the real estate toolbar. An option may also be included to save the results of the real estate search so that the results may recalled at a later time.

A real estate toolbar may also include a various other functions relating to real estate searching, including, but not limited to, functions relating to home finance, moving, and home and garden improvement. For example, an embodiment of the real estate search toolbar may include home finance tools such as the ability to receive updated mortgage rates and quotes from various lenders, calculators such as mortgage payment calculators and home affordability calculators, as well as advertisements from various vendors and articles covering various subjects relating to home finance. A real estate toolbar may also include moving tools such as the ability to receive updated moving quotes from various moving vendors, as well as various advertisements and articles relating to moving. A real estate toolbar may also include home and garden tools such as the articles and advertisements relating to home and garden improvement.

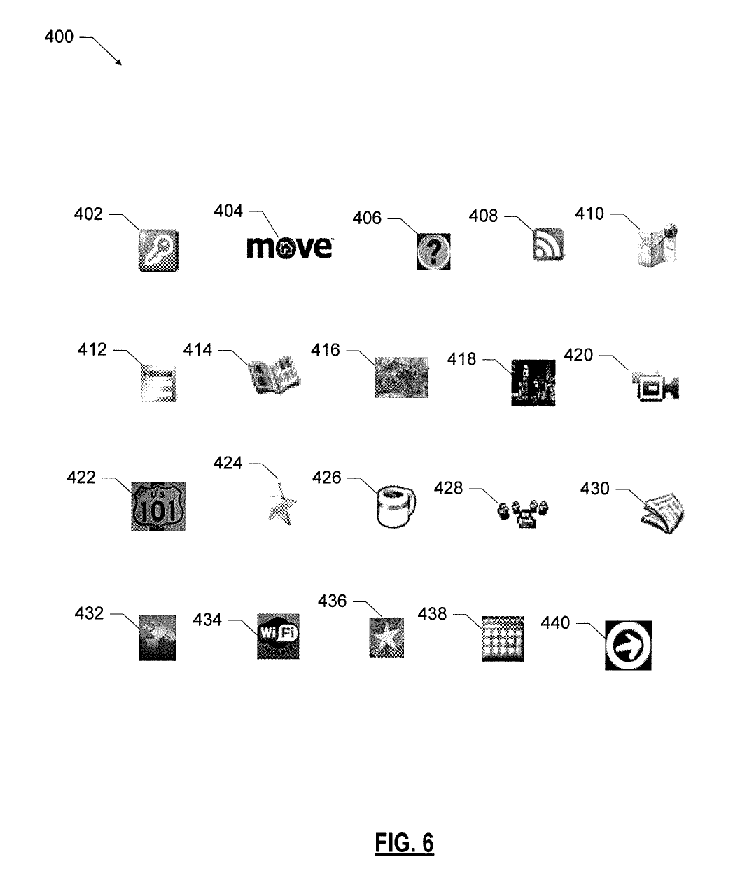

FIG. 6 depicts a set of icons 400 associated with real estate search tools according to another exemplary embodiment of the real estate search toolbar. The icons 400 may be arranged and customized on the real estate toolbar by a user. It should be noted that the graphical representation of the icons of this exemplary embodiment were selected to connote the real estate search tool associated with the icon, however in other embodiments, other graphical representations may be used.

An SSO tool and associated icon 402 may be included that allows access to all locked network resources, such as private real estate data, and which may save custom settings and preferences. A search function tool and associated icon 404 may be included that allows a user to enter search criteria and receive search results relating to available real estate properties, including, but not limited to, new homes, rentals, re-sale properties, etc. A help function tool and associated icon 406 may be included that is configured to help a user learn how to operate the real estate search toolbar. A listing feed detector tool and associated icon 408 may be included that identifies an RSS or Atom feed for a website hosted by a listing service provider, real estate agent, or other member of a network and allows a user to add the it to the real estate search toolbar so that a user may be directed to that website directly from the real estate search toolbar. A maps function tool and associated icon 410 may be included that may provide a user with maps and/or directions to and from real estate properties identified through a search. A saved search properties filler function tool and associated icon 412 may be included that may auto-fill forms at visited websites with criteria previously entered by a user. A blog search function tool and associated icon 414 may be included that allows a user to search for real estate related articles and displays search results relating to real estate blog articles. A fly-by function tool and associated icon 416 may be included that may provide satellite and/or aerial fly-bys of searched properties. A neighborhood drive-by function tool and associated icon 418 may be included that may provide virtual a neighborhood drive-through of selected properties. A virtual tour video function tool and associated icon 420 may be included that may provide virtual tours of the interior of selected properties.

A directions function tool and associated icon 422 may be also included that provides directions to and/or from selected properties. A book-marking function tool and associated icon 424 may be included that allows a user to bookmark properties so that direct access may be gained to that property from other locations on a network. A local businesses listing function tool and associated icon 426 may be included that provides a user with a list of local shops, cafes, businesses, etc. within a searched neighborhood. A social network listing function tool and associated icon 428 may be included that allows users to contact local experts in an area. A real estate news function tool and associated icon 430 may also be included that allows a user to search for real-estate related news articles. An international real estate searching function tool and associated icon 432 may be provided that allows a user to search for real-estate in foreign countries. A wireless synchronization function tool and associated icon 434 may be included that allows a user to synchronize saved properties with a wireless device; for GPS enabled devices, synchronized data may include latitudinal and longitudinal coordinates. A comparables listing function tool and associated icon 436 may be included that provides a user with a list of comparable sold properties. A calendar of open-houses function tool and associated icon 438 may be included that provides a user with a list of open-house locations, times, dates, etc. in an area that a user has searched. An other options function tool and associated icon may be included that provides users with a list of other options, including, but not limited to, directing user to a site rank website wherein users are provided with a ranked list of websites, an auto-complete function that completes entries by a user and then provides a user with the number of results that may return using the auto-completed criteria, and an address mapping function that creates a hyperlink allowing a user to map an address and view comparable sales data, etc.

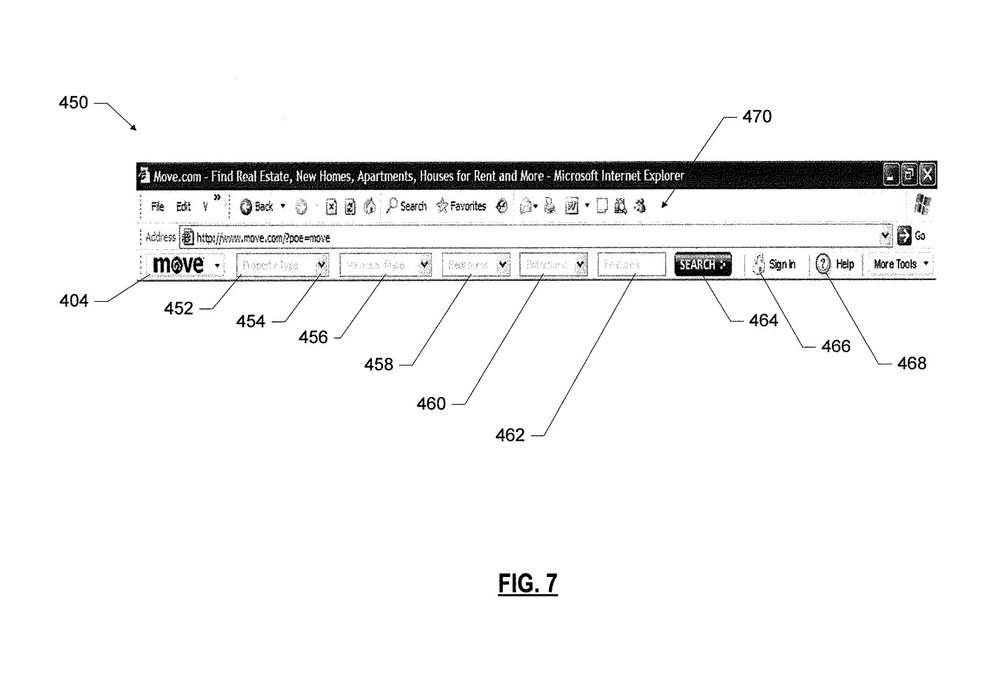

FIG. 7 shows a real estate search toolbar 450 in accordance with one embodiment of the present invention. As shown in the figure, the real estate search toolbar 450 may include a search function tool and associated icon 404. Search criteria data entry fields may also be included, such as a property type field 452, a maximum price field 456, a number of bedrooms field 458, a number of bathrooms field 460, and a features field 462. For each of these, a drop down menu button 454 may be included. The drop down button 454 may provide a user with popular selections for each of the data fields. For example, drop down selections for the property type field 452 may include single family listings, multi-family listings, homesites, etc. A search icon 464 may also be included that begins a user's search based on the provided criteria in above fields. As noted above, the real estate search toolbar 450 may also include an SSO sign-in icon 466 that allows a user to perform a single sign-in in order to access private data as described above. A help icon 468 may also be included. Additionally, the real estate search toolbar 450 may include popular navigation, administrative, file management, and other functions represented by various icons 470 as shown in the figure.

The foregoing merely illustrates how exemplary embodiments of the present invention provide a real estate lockbox and a real estate search toolbar. Referring now to FIG. 7, a block diagram of an exemplary electronic device (e.g., PC, laptop, PDA, etc.) 500 configured to execute the method of providing a real estate lockbox or the method of providing a real estate search toolbar of exemplary embodiments of the present invention are shown. The electronic device 500 may include various means for performing one or more functions in accordance with exemplary embodiments of the present invention, including those more particularly shown and described herein. It should be understood, however, that the electronic device may include alternative means for performing one or more like functions, without departing from the spirit and scope of the present invention. As shown, the electronic device may generally include means, such as a processor, controller, or the like 502 connected to a memory 504, for performing or controlling the various functions of the entity.

The memory can comprise volatile and/or non-volatile memory, and typically stores content, data or the like. For example, the memory typically stores content transmitted from, and/or received by, the electronic device. Also for example, the memory typically stores software applications, instructions or the like for the processor to perform steps associated with operation of the electronic device in accordance with embodiments of the present invention. In particular, the memory 504 may store computer program code for an application and other computer programs. For example, in one exemplary embodiment of the present invention, the memory may store computer program code for, among other things, providing a real estate lockbox, or providing a real estate search toolbar.

In addition to the memory 504, the processor 502 can also be connected to at least one interface or other means for displaying, transmitting and/or receiving data, content or the like. In this regard, the interface(s) can include at least one communication interface 506 or other means for transmitting and/or receiving data, content or the like, as well as at least one user interface that can include a display 508 and/or a user input interface 510. The user input interface, in turn, can comprise any of a number of devices allowing the electronic device to receive data from a user, such as a keypad, a touch display, a joystick or other input device.

As described above and as will be appreciated by one skilled in the art, embodiments of the present invention may be configured as a method and apparatus. Accordingly, embodiments of the present invention may be comprised of various means including entirely of hardware, entirely of software, or any combination of software and hardware. Furthermore, embodiments of the present invention may take the form of a computer program product consisting of a computer-readable storage medium (e.g., the memory 504 of FIG. 16) and computer-readable program instructions (e.g., computer software) stored in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of managing access over a network to real estate data relating to one or more real estate properties, said method comprising:
providing data related to real estate property, wherein at least some of the data is considered private data not meant for access by the general public and some of the data associated with real estate property is considered public data meant for access by the general public;
associating a security key with the private data; and
allowing access to the private data to users possessing the security key.

2. The method of claim 1, further comprising registering a user for access to private data and issuing a security key to the user following registration.

3. The method of claim 1, wherein there are various pieces of private data, wherein some of the pieces of private data have an associated different level of security, and wherein said associating step associates different security keys for each level of private data.

4. The method of claim 3, further comprising registering a user for access to private data and issuing a security key to the user following registration, wherein said registering and issuing require added information from the user for providing security keys of different levels of private data to the user.

5. The method of claim 1, wherein said associating step comprises the step of encoding the private data and the security key is a private decryption key.

6. The method of claim 1, wherein the security key is an authentication token used to request the private data.

7. The method of claim 1, wherein the security key is a decryption key that decrypts the private data.

8. The method of claim 7, wherein the decryption key is stored inside one or more HTTP session objects.

9. The method of claim 8, wherein the decryption key is stored inside one or more cookies resident to a browser session.

10. A method of managing access over a network to real estate data relating to one or more real estate properties, said method comprising:
providing data related to real estate property, wherein at least some of the data is considered private data not meant for access by the general public and some of the data associated with real estate property is considered public data meant for access by the general public;
associating a security key with the private data;
displaying public data relating to the real estate property to a user; and
denying access to private data relating to the real estate property.

11. The method of claim 10 further comprising allowing access to the private data to users possessing the security key.

12. A computer program product for managing access over a network to real estate data relating one or more real estate properties comprising a computer-readable storage medium having computer-readable program code portions stored therein, the computer-readable program code portions comprising:
first executable portion configured to receive data related to real estate property, wherein at least some of the data is considered private data not meant for access by the general public and some of the data associated with real estate property is considered public data meant for access by the general public;
second executable portion configured to associate a security key with the private data; and
third executable portion configured to allow access to the private data to users possessing the security key.

13. The computer program product of claim 12, further comprising fourth executable portion configured to register a user for access to private data and issue a security key to the user following registration.

14. The computer program product of claim 12, wherein there are various pieces of private data, wherein some of the pieces of private data have an associated different level of security, and wherein said second executable portion is configured to associate different security keys for each level of private data.

15. The computer program product of claim 14, further comprising fourth executable portion configured to register a user for access to private data and issue a security key to the user following registration, wherein said registering and issuing require added information from the user for providing security keys of different levels of private data to the user.

16. The computer program product of claim 12, wherein said second executable portion is configured to encode the private data and the security key is a private decryption key.

17. The computer program product of claim 12, wherein the security key is an authentication token used to request the private data.

18. The computer program product of claim 12, wherein the security key is a decryption key that decrypts the private data.

19. The computer program product of claim 18, wherein the decryption key is stored inside one or more HTTP session objects.

20. The computer program product of claim 19, wherein the decryption key is stored inside one or more cookies resident to a browser session.

21. A system for facilitating a search for real estate over a network, said system comprising:
at least one server comprising real estate listings, wherein the listings contain data about real estate properties;
a computing element in communication with said server, said computing element comprising:
an operating system for managing hardware and software of the computing element;
a browser software program for use in accessing and displaying webpages; and
a search toolbar application program interface that is separate from said browser software and which provides at least one real estate search criteria data entry field.

22. The system of claim 21, wherein the search toolbar application program interface comprises at least one interactive portion and at least one display portion.

23. The system of claim 21, wherein the real estate search criteria data entry fields are configured to accept search criteria data relating to the real estate listings.

24. The system of claim 21, wherein the search toolbar application program interface is configured to access the real estate listings on the at least one server, to search the real estate listing according to the search criteria data, and to provide results relating to the searched real estate listings.

25. The system of claim 23, wherein the search criteria data includes at least one of a property type field, a price field, a number of bedrooms field, a number of bathrooms field, and a features field.

26. The system of claim 21, wherein the search toolbar application program interface further comprises a sign-on function.

27. The system of claim 26, wherein at least some of the data is considered private data not meant for access by the general public and some of the data associated with real estate properties is considered public data meant for access by the general public, wherein a security key is associated with the private data, and wherein the sign-on function of the search toolbar application program interface is configured to provide access to a security key.

28. The system of claim 27 wherein the private data is encoded and the security key is a private decryption key.

29. The method of claim 27, wherein the security key is an authentication token used to request the private data.

30. The method of claim 27, wherein the security key is a decryption key that decrypts the private data.

31. The method of claim 28, wherein the decryption key is stored inside one or more HTTP session objects.

32. The method of claim 31, wherein the decryption key is stored inside one or more cookies resident to a browser session.
